(19) United States
(12) Patent Application Publication
(10) Pub. No.: US 2025/0346068 A1
(43) Pub. Date: Nov. 13, 2025

(54) OMNI WHEEL

(71) Applicant: Rotacaster Wheel Pty Ltd, Beresfield NSW (AU)

(72) Inventor: Peter Rodney McKinnon, Beresfield NSW (AU)

(21) Appl. No.: 18/659,462

(22) Filed: May 9, 2024

(51) Int. Cl. B60B 19/00; B60B 19/12

(52) U.S. Cl. CPC B60B 19/003; B60B 19/12

(57) ABSTRACT

An omniwheel 100 comprising a central hub 150 from which extends a plurality of radially extending spokes 110, each spoke 110 terminating with an outer radial head 112, each pair of adjacent radial heads radially spaced from the central hub 150 have extending therebetween a roller axle for supporting a roller 104 adapted to rotate about an axis 105 perpendicular to a virtual radial line 124 extending from a main axis 108 of rotation of the wheel 104, wherein the outer periphery of the central hub 150 includes a cylindrical outer wall 156 supporting for each radial head a pair of radially outwardly extending spoke arms 146 defining therebetween a triangular, diamond or arrow-head shaped hollow 142, the pair of outwardly extending spoke arms 146 converging to meet to form a spoke neck portion 134 that supports the corresponding radial head 112.

### FIELD OF INVENTION

This invention relates to an omniwheel.

### BACKGROUND ART

Omniwheels have become important components in a variety of fields utilising multiple directional wheels, including materials conveying, package and parcel transport, and robotics. The materials, such as metals and plastics, used to make the frames of such omniwheels are expensive. The preferred properties are a combination of being lightweight, resilient or rigidi, and strong. There is an advantage in minimising the amount of materials and individual components used in manufacturing the wheel.

Omniwheels can be readily power driven to provide precision mobility for robots. They can also be inverted, that is positioned to run under a contacting surface rather than on top of it, for example for multi-directional conveying and sortation within conveyer feed table applications. Conveyance and sortation applications require high load-bearing capacity, whereas in robotics lighter weight wheel frames are an advantage.

Prior art omniwheels frames are typically either strong, thick and heavy, or they are fragile and not suited to heavy load-bearing. The single rim fragile frames may comprise assembled components that are joined by metal fasteners. This can create an undesirable hardness differential with metal fasteners bearing against softer plastic frames.

An omniwheel typically comprises a double rim or double frame to form the wheel unit. Applicant's omniwheels comprise two wheel frames or bodies, each having a rim, so that each assembled omniwheel typically has two rims. Each wheel frame supports a plurality of rollers. In the present invention, the Applicant's wheel frames support 8 or 9 rollers each, so that the assembled dual rimmed omniwheel has 16 or 18 peripheral rollers.

### OBJECT

An object of the present invention is to address one or more of the disadvantages of the prior art or to at least provide a useful alternative.

### STATEMENT OF INVENTION

The invention provides:

An omniwheel including a wheel frame supporting a total of 8 or 9 peripheral rollers and a corresponding number of radially extending spokes, each spoke including a pair of radially extending curved spoke arms that radially outwardly converge to support a radial head adapted to support one end of a roller axle extending between adjacent pairs of radial heads on the same wheel frame, each spoke arm having a geometric relationship to another spoke arm of the wheel frame forming a multi-pointed star shape, which star shape is repeated and overlapping throughout the wheel frame structure.

The star shape is preferably defined by multiple in-line pairs of spoke arms together having a geometric connection across the wheel frame, the in-line pair of spoke arms shaped to conform to a contour path that follows a symmetrical curved line between the inline pair of spoke arms, the contour path having an average radius within 20%, preferably 10%, of either 2R or R, where R is the radius of the omniwheel from a main central rotational axis of the omniwheel to an outermost rim of the omniwheel corresponding to a ground-contacting surface of one of the rollers on the wheel frame.

In another aspect, an omniwheel including a wheel frame supporting a total of 8 or 9 peripheral rollers and a corresponding number of radially extending spokes, each spoke including a pair of radially extending curved spoke arms that radially outwardly converge to support a radial head adapted to support one end of a roller axle extending between adjacent pairs of radial heads on the same wheel frame, each spoke arm having a geometric relationship to another spoke arm of the wheel frame forming an in-line pair of spoke arms with a geometric connection across the wheel frame, the in-line pair of spoke arms shaped to conform to a contour path that follows a symmetrical curved line between the inline pair of spoke arms, the contour path having an average radius within 20%, preferably 10%, of either 2R or R, where R is the radius of the omniwheel from a main central rotational axis of the omniwheel to an outermost rim of the omniwheel corresponding to a ground-contacting surface of one of the rollers on the wheel frame.

### Frame

The omniwheel may include only one wheel frame, for example for conveyance and sorting applications. The wheel frame may be one of multiple wheel frames used in the assembly of the omniwheel. Typically, omniwheels for ground-engaging applications, the omniwheel includes two wheel frames having a corresponding pair of rims.

There are competing spatial constraints involved in omniwheel frame design. The space between peripheral rollers must be maximised to ensure good diagonally adjacent roller overlap by minimising the circumferential with of the spokes. However, the outer radial heads of the spokes supporting the rollers cannot be too thin or they will be structurally compromised. Moreover, although the omniwheel frame must be strong, it is preferably also as light-weight as possible. Still more preferably, the frame is unitarily formed in one piece for each roller race.

### Rollers

Each pair of adjacent heads has extending therebetween a roller axle for supporting one of the peripheral rollers for rotation about a roller axis that is perpendicular to the main axis.

### Roller Bushing

The roller preferably includes a bushing. The roller includes sleeve material, such as a synthetic pliable rubber compound. The sleeve material may be overmoulded on to the bushing to form the roller on the frame. Preferably, the bushing is in the form of a helical bushing as described in WO2014089642 by the Applicant.

### Radial Head

The radial head has a substantially trapezoidal or triangular shaped head. The spoke has a dual triangular structure with the angle of approach of the spoke arms at the spoke neck balancing the triangular form of the radial head with an hourglass or “FIG. 8” shape. Loads applied to the radial head may be effectively dispersed through the neck to the spoke arms, enabling a frame using minimal material.

### Radial Arms/Spokes

Preferably, each spoke has a unique direct spatial and structural relationship through the central hub to two other spokes. The spoke arm of one spoke preferably follows a direct line or curve through the central hub to a spaced spoke arm of another spoke of the wheel frame. The direct line or curve may be the contour path.

The radial spokes extend from the central hub and combine with the hub to form a central star frame having identifiable multiple, over-laid star shapes. In the central star frame, each individual spoke defines a hollow triangular, diamond or arrow-head shape.

### Hub/Bore

The bearing seat may be combined with an interchangeable inner bore. The inner bore may be a polygonally keyed inner bore, such as a hex inner bore. The internal corners of the bore are preferably undercut to enable slight distortion of the polygonal shape to retain inserts in a friction or interference fit. The undercuts may be internally radiused corners that resist splitting but allow flex thereby facilitating the reception of a polygonal shaped insert.

### Dual Rim Wheels

The wheel may comprise a pair of omniwheel races, each race comprising a frame with a hub, and 8 or 9 rollers. To engage a pair of wheel races, the frames of one or both wheel races may include a combination of protrusions and complementary recesses. The pairs of races may be joined by an engagement involving an interference fit. The interference fit may involve the insertion of pins of one shape (for example, cylindrical) into holes of a geometrically different shape (for example, hexagonal). The interference fit preferably includes round pins inserted in hexagonal holes, which may be described as a “Mattel lock”. Although it might be anticipated that the internal walls of the hexagonal hole may distort slightly, it is believed that the pin distorts from its circular cross-section to exert a large surface pressure on the flats of the hex. rather than the hex distorting, you want the hex to not distort,] to accommodate the pin. The pin may have a slightly larger diameter than the maximum breadth of the hexagonal hole, for example about 0.05 mm-0.3 mm larger. The arrangement may include an array of pins on an inner face of the wheel body (the central hub) of the first race. Advantageously, circumferentially offset from the array of pins may be a corresponding and complementary array of hexagonal recesses. The offset arrangement of the pin and recess arrays on the same inner hub face allow for a combination of two identical halves to form a dual race symmetrical wheel body. Moreover, the provision of both male and female engagement members on both identical halves provides for a strong, bisymmetrical engagement.

### BRIEF DESCRIPTION OF THE DRAWINGS

The invention may be better understood from the following non-limiting description of preferred embodiments, in which:

FIGS. 1a-b are perspective views of a dual rim omniwheel according to a first embodiment having 8 rollers;

FIG. 1c is a front view of an omniwheel according to the first embodiment;

FIGS. 1d-e are top views of the omniwheel according to the first embodiment;

FIGS. 2a-b are front and rear elevations of an omniwheel according to a second embodiment having 9 rollers;

FIG. 3 is a rear perspective view of a single wheel frame of the omniwheel according to the second embodiment;

FIG. 4 is a rear view of a central hub of the omniwheel according to the second embodiment;

FIG. 5a is a front view of the single rim omniwheel shown in FIG. 3 according to the second embodiment;

FIG. 5b is a magnified view of portion A from FIG. 5a;

FIG. 6a is a front view of the single rim omniwheel shown in FIG. 5a;

FIG. 6b is a magnified view of portion B from FIG. 6a;

FIG. 6c is a magnified view of portion C from FIG. 6b;

FIG. 7 is a front view of the single rim omniwheel according to the second embodiment shown in FIG. 5a;

FIG. 8a is a cross-sectional view through section Dt-Dt FIG. 7;

FIG. 8b is a magnified view of portion E from FIG. 8a;

FIG. 9 is a side view of a roller forming part of either the first or second embodiment and having 13 annular ribs;

FIG. 10 is a side view of a roller forming part of either the first or second embodiment and having 9 annular ribs;

FIGS. 11a-c is a side-by-side comparison of the perspective views of actual images of a prior art omniwheel and the omniwheels of the first and second embodiments, standing parallel to each other;

FIGS. 12a-c are respectively front, rear and perspective views of a single rim frame of an omniwheel according to the first embodiment having a wheel diameter of 127 mm;

FIGS. 13a-c are respectively front, rear and perspective views of a single rim frame of an omni wheel according to the second embodiment having a wheel diameter of 180 mm; and

FIGS. 14a-b are respectively a front view, and rear perspective view, of, like FIGS. 12a-c, a single rim frame of an omniwheel according to the first embodiment having a wheel diameter of 127 mm.

### DETAILED DESCRIPTION OF THE DRAWINGS

Preferred features of the present invention will now be described with particular reference to the accompanying drawings.

### Definitions, Meanings, Qualifications and Explanations

### Omniwheel

The drawings show an omniwheel 100 having 8 rollers 104 per wheel frame 140 or wheel race. The drawings also show an omniwheel 200 according to a second embodiment having 9 rollers 104 per wheel frame 140.200. In describing the omniwheels 100,200 with reference to the drawings, like features are given the same reference number. The wheel frames 140 of each omniwheel 100,200 comprise a central hub 150 from which extends a plurality of radially extending spokes 110, each spoke 110 terminating with an outer radial head 112, each pair of adjacent radial heads radially spaced from the central hub 150 have extending therebetween a roller axle in the form of a solid cylindrically shaped rod for supporting a roller 104 adapted to rotate about an axis 105 perpendicular to a radial line 124 extending from a main axis 108 of rotation of the wheel 104, wherein the outer periphery of the central hub 150 includes a plurality of solid triangular bases 147 radially aligned with a corresponding roller 104, each adjacent pair of triangular bases 147 together with a pair of radially outwardly extending spoke arms 146 defining therebetween a triangular, diamond or arrow-head shaped hollow 142, the pair of outwardly extending spoke arms 146 converging to meet to form a spoke neck portion 134 that supports a corresponding one of the radial heads 112.

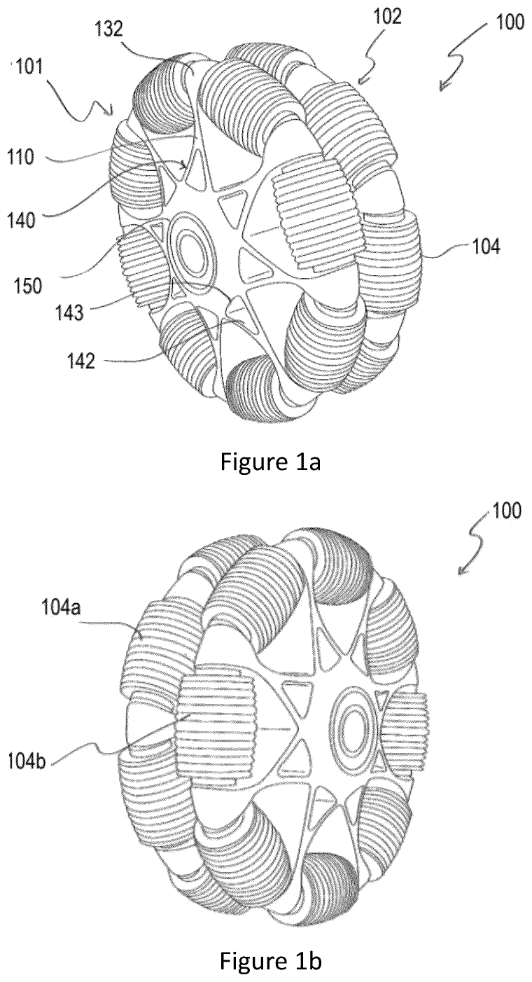

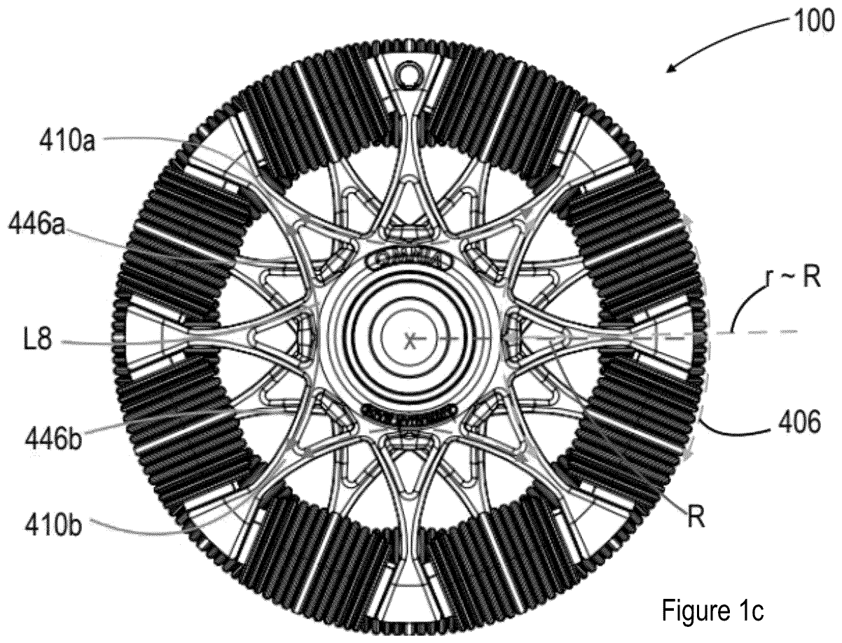

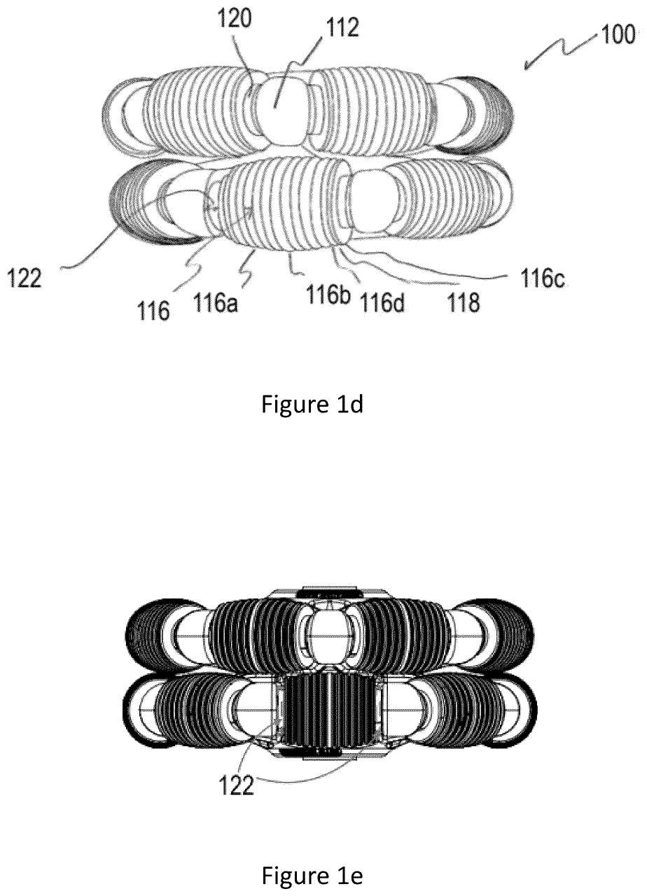

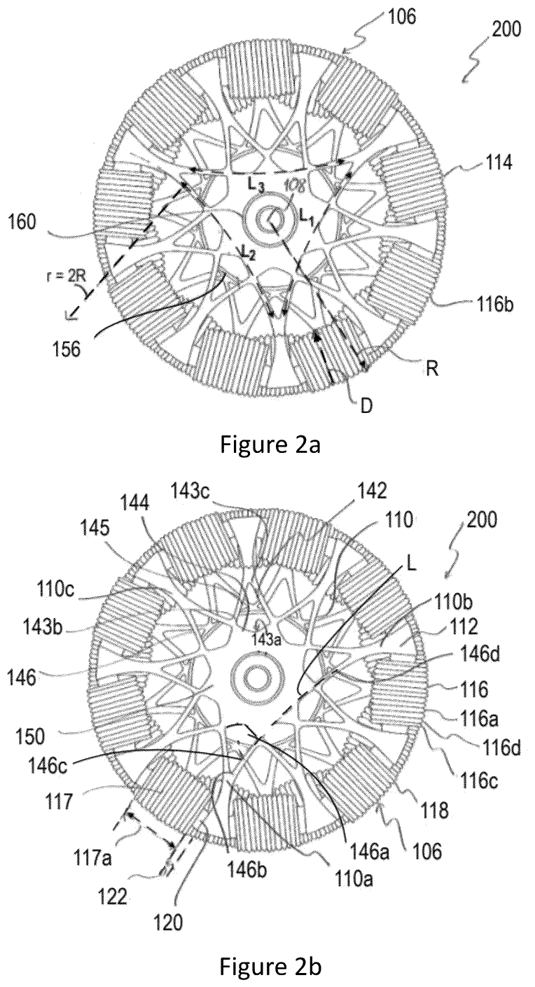

FIGS. 1a-3 show an omniwheel 100 according to a first embodiment of the invention. The omniwheel has a pair of parallel-planar, coaxially aligned and adjacent races 101,102 of rollers 104, each roller 104a of the first race 101 offset from each roller 104b diagonally adjacent in the second race 102. The offset arrangement of the rollers 104a of the first race 101 complement the positioning of the rollers 104b of the second race to present, in side elevation as shown in FIGS. 2a-b, a continuous, substantially round, peripheral surface 106. The continuous peripheral surface 106 enables the wheel 100, when rotated about the main axis 108, to provide a smooth, non-bumpy ride. Each roller 104 is mounted on a roller axle supported between an adjacent pairs of radial heads at the terminal end of radially outwardly extending spokes 110. The radial head 112 is radially slightly recessed so that it is the rollers 104, not the radial heads 112, that contact exterior surfaces, such as the ground.

### Rollers

The omniwheel may include two or more races of rollers 104, each race 101,102 forming a rim.

The rollers 104 have a frusto-fusiform, solid torpedo or cigar shape. The outer surface 114 of the rollers 104 is slightly convexly curved to correspond to the approximate radius R as a whole of the omniwheel 100. The rollers 104 are of a consistent length to correspond to a universal (within the Applicant's range of products) bushing 120, although their diameter and the radius of the curve of their outer surface 114 may vary depending on the size of the omniwheel. Internally, within its own omniwheel product range, Applicant has standardised the length of its roller 104 to be approx. 28.5 mm in length. Depending on the omniwheel's 100 primary radius R, the roller's 104 outer surface 114 curve may vary to correspond to a radius of 45 mm, 63.5 mm, 75 mm and 90 mm, respectively corresponding to omniwheels 100 with diameters of 90 mm, 127 mm, 150 mm and 180 mm. However, the constant length of the roller 104 allows Applicant to use the same bushing 120 across its range of omniwheels 100 into the future.

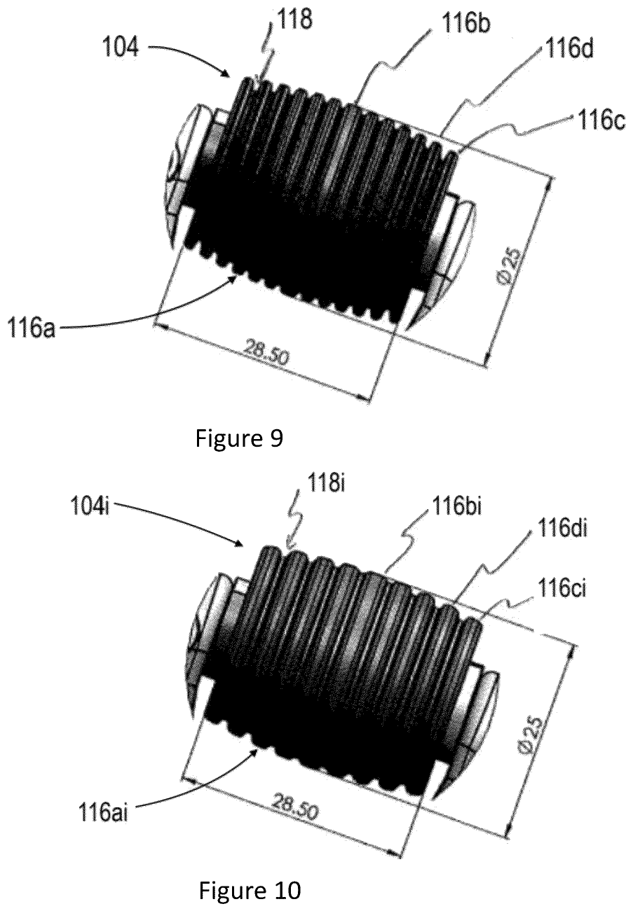

A preferred roller surface has a ribbed profile 116 as shown in FIGS. 9-10. Irrespective of the roller's 104 diameter, the style of ribs 116a can be consistent across a range of wheels 100, with the number of radial ribs 116a being an odd number of either 9, 11 or 13 with, respectively, the 5th, 6th or 7th central rib 116b,116bi flanked by an equal even number of ribs 116a,116ai extending to either end of the roller 104 either side of the central rib 116b,116bi. Endmost ribs 116c,116ci at each end have great flex and resilient deformability as the crevice, gap or groove 118,118i between the endmost rib 116c,116ci and the penultimate end rib 116d,116di allows significant play of the endmost rib 116c,116ci. This enables a smooth and non-bumpy pass off from one roller 104a to its diagonally adjacent roller 104b. Furthermore, overall, the resilient deformability of the ribbed profile 116 and the individual ribs 116a-d improves the smoothness of the ride of the omniwheel 100.

The wide central rib 116b of the roller 104,104i is flanked by shallow grooves 118,118i. The grooves 118,118i are progressively deeper toward the penultimate ribs 116d,116di and the endmost ribs 116c,116ci.

### Helical Roller Bushing

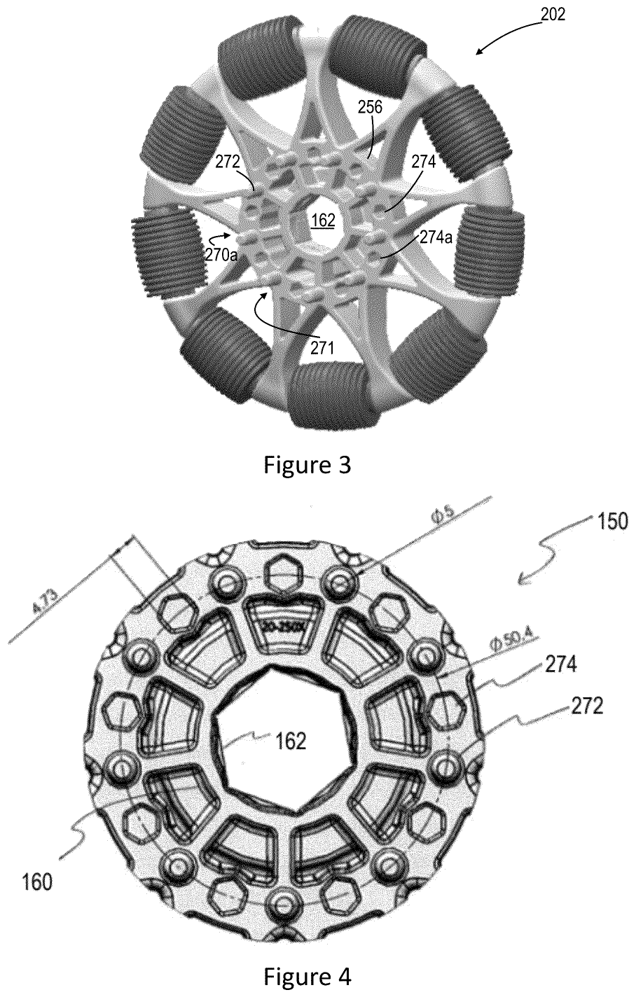

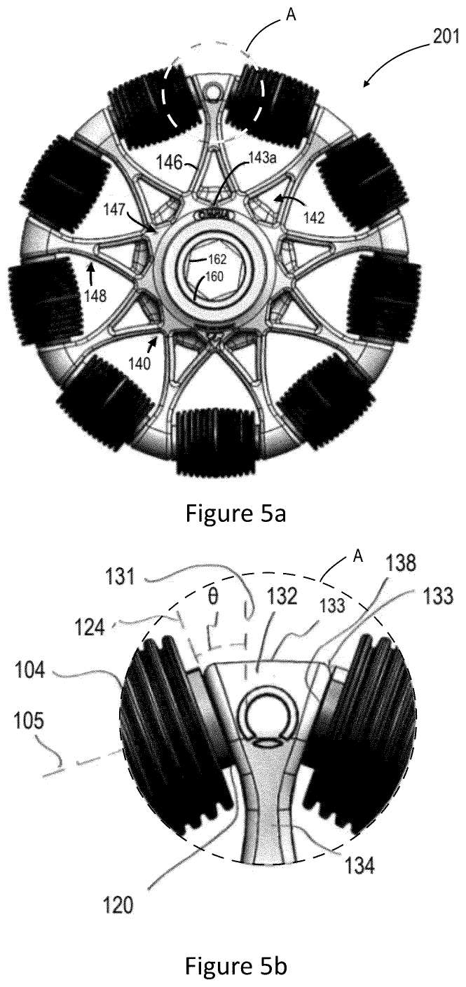

With particular attention to FIGS. 2b-3, the omniwheel race 201 is described with reference to FIGS. 4-9b, and particularly with regard to FIGS. 9a-9b, noting that the discussion pertains to all embodiments of the invention described in this specification. The bushing 120 is in the form of the helical bushing 10 described in PCT specification No. 2014089642 by the Applicant, the entire contents of which are hereby incorporated by reference. The helical bushing 120 is advantageously over-moulded with roller sleeve material 117 forming the ribs 116a moulded onto the bushing 120 to form the roller 104. This requires a minimum area 122 beyond the roller sleeve material 117 that consists of the respective ends of the bushing 120 to be able to shut off the sleeve moulding tool (not shown). If the minimum area 122 is too small, it can be difficult to stop flashing of the sleeve material 117. Flashing can be removed, but can require the performance of an additional step and/or require additional manufacturing time. If the minimum area 122 is too large, the roller length 117a or its diameter would need to be reduced, thereby adversely affecting the smoothness of the transition from the roller 104a to its diagonally adjacent roller 104b, which can harm ride quality. Referring to FIG. 2b, in a roller 104 with a roller sleeve length of between 25-30 mm, preferably 28-29 mm, and most preferably 28.5 mm, the minimum area 122 may vary between 1.5-2 mm, preferably 1.8-1.9 mm, and most preferably about 1.85 mm, irrespective of the number of ribs 116a.

### Frame

A wheel frame 140 may be made from strong mouldable or castable materials such as titanium or other expensive lightweight metals and their alloys, and preferably strong plastic, such as acetal.

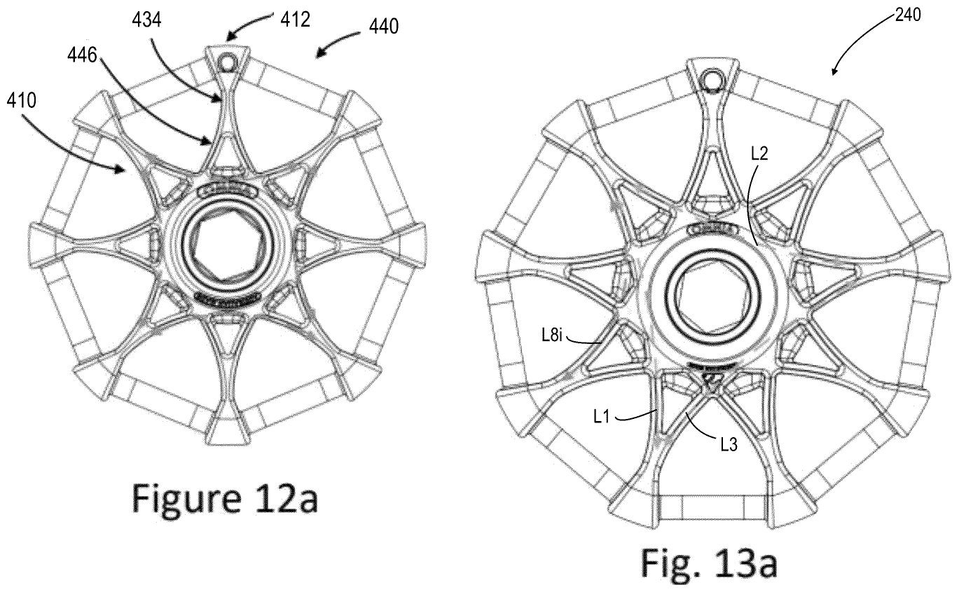

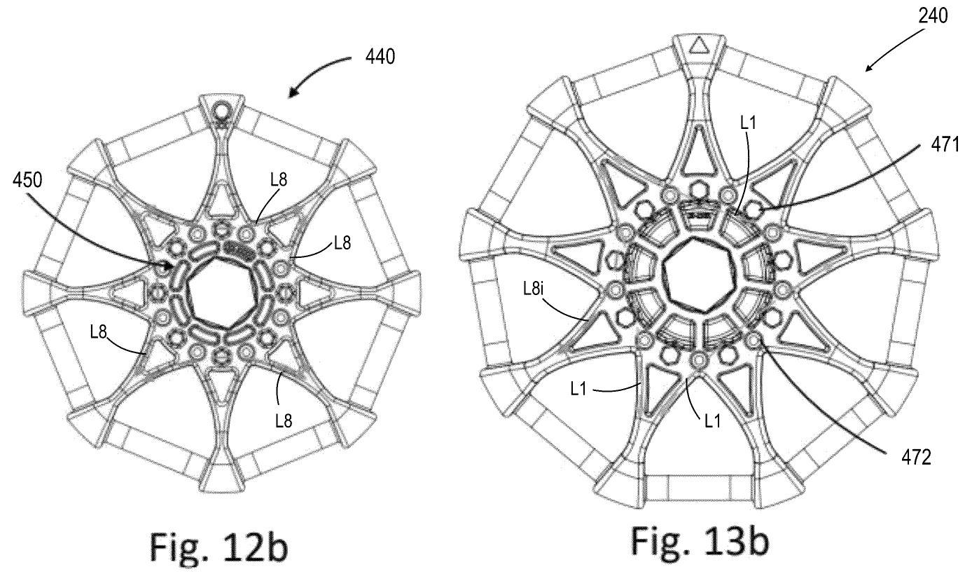

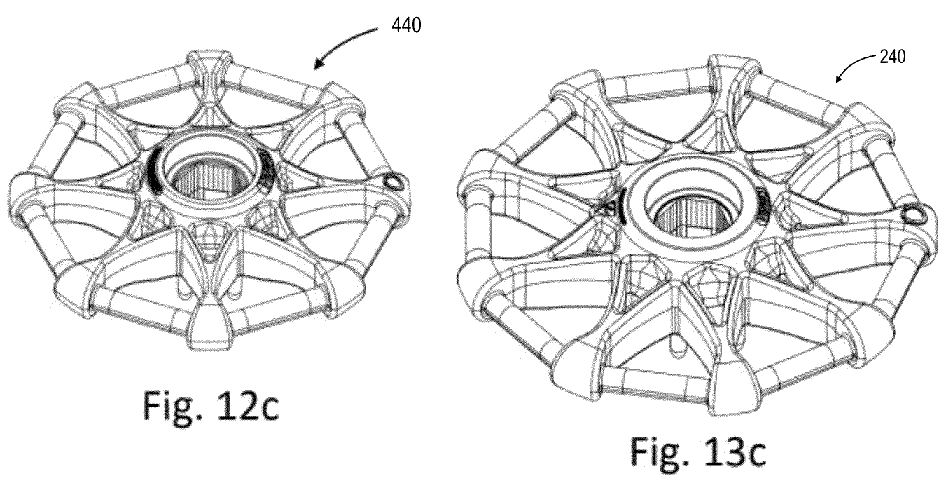

The frame 140 for each omniwheel race comprises the radial heads 112. Extending between adjacent radial heads 112c of a frame 140 of a single race are the roller axles 480. The combination of the radial heads 112 and the roller axles 480 in continuous unitarily moulded connection, all located in the same plane of the wheel frame 140 forms a continuous polygonally shaped ring structure. As can be seen in FIGS. 12a-e, the roller axles 480, the spokes 110 and the central hub 150, are all formed from the same unitary single mould of material. This forms an extremely strong wheel frame 140 structure, including the roller axles 480. The spokes 110 (including the spoke arms 146, the spoke necks 134 and the radial heads 112) are formed with a material that is continuous with no separate components, joins or fastening connections, to the central core or hub 150 of the wheel frame 140. The central core predominantly includes the central hub 150.

The polyaxled ring (the combination of the peripheral portion of the frame 140 comprising the radial heads 112 and the roller axles 480) act in tension with the spokes 110 and the central core 150 to support, and strongly fix in position relative to the core 150, the radial heads 112 against forces that would otherwise distort the wheel frame 140. In use, as compression forces F are applied to a ground-contacting roller 104 and the roller axle 480 on which it is amounted, the force F is dispersed inwardly radially through the radial heads 112 unitarily formed with this load-bearing roller axle 480. The force F is further dispersed through roller axles 480 unitarily formed with the radial heads 112 either side of the load-bearing axle 480, and thereafter throughout the wheel frame 140, including the spokes 110 and other roller axles 480.

The force F is further dispersed through the spokes 110 which each have a unique spatial and structural relationship through the central hub 150 to at least one other spoke 110.

### Radial Head

The radial head has a substantially trapezoidal or triangular shaped head 132. The spoke 110 has a dual triangular structure (radial head 132 and spoke arm and base triangle 142) with the angle of approach of the spoke arms 146 at the spoke neck 134 balancing the triangular form of the radial head 132 with an hourglass or “FIG. 8” shape. Loads applied to the radial head 132 may be effectively dispersed through the neck 134 to the spoke arms 146, enabling minimal material to be used to form the frame 140.

The frame 140 for each omniwheel race 201,202 comprises the radial heads 132, the roller axles extending between each adjacent pair of radial heads 132, the spoke neck 134, the spoke arms 146 and the central hub 150, all being formed from the same unitary single mould of material.

Impacts to the radial head 112 may occur in use. This can damage or collapse the end material of the bushing 120, which may increase friction and restrict roller 104 rotation. The monolithic form of the frame 140, including the inner circular central hub 150 and the outer unitary continuous ring of roller axles, the central hub 150 and the radial heads 132 radially bridged by the respective, overlapping and mutually reinforcing pairs of inline spoke arms 146, provides a frame 140 of great strength that resists distortion from radially inward impact forces.

The radial head 112 comprises a substantially triangular head 132 continuous and contiguous with a narrow neck 134 radially intermediate the length of the spoke 110 and a central hub 150. The head has a radially outermost end wall 136 having a curve with a radius that generally corresponds or equates to radius R of the omniwheel 100. The head 132 has side walls 138 extending between the neck 134 and the outer wall 136 at an angle θ, which has a range of 17°-23°, preferably about 20° to a virtual radial line 131 extending from the main axis 108. This places the side wall 138 at an angle normal to a rotational axis 105 of the opposing roller 104 (which is coaxial with the corresponding roller axle) and parallel adjacent (adjacent coplanar) to the plane 124 in which the terminal edge of the bushing end 120 lies. The corner 133 transition between the outer wall 136 and the side wall 138 is radiused. This provides space for the edge of the bushing end 120 to distort into without stressing the material through abutment. This is counterintuitive as the load applied radially inwardly through the head 132 would be expected to distort the end ribs 116c-d of the roller 104 away from the head 132. However, this geometric and structural relationship between the head 132 and the bushing 120 decreases the stress and load on the edge of the bushing end 120.

### Radial Arms/Spokes

The radial spokes 110 extend from the central hub 150 and combine with the hub 150 to form a central star frame (see FIGS. 2a, 6a and 10 outlining the 3 and 4 point star shapes formed by the hub 150 multiple sets of spokes 110). The star shapes are identifiable multiple, over-laid star shapes.

The central star frame comprises 3 or 4 point sub-units for corresponding 9 and 8 roller races of omniwheels (an omniwheel 100,400) with diagonally adjacent overlapping rollers 104 comprising multiples of 9 and 8 rollers 104). The spoke arm 146 of each pair of spoke arms 110 belong to one spoke 110 that is adapted to resiliently flex inwardly toward the other spoke arm 146 of the pair 146.

The pairs of spoke arms 146 belonging to a spoke 110 may be curved and be in the form of inwardly arched walls 148 that each extend radially outwardly from the triangular base that they form to the neck. The arched walls, together with the central star shaped frame including the central hub 150 and the triangular bases, radially resist compression from centripetal loads applied to the omniwheel 100.

The radial spokes 110 extend from the central hub 150 and combine with the hub 150 to form a central star frame 140 in which each individual spoke 110 defines a hollow triangular, diamond or arrow-head shape 142. The hollow shape 142 is shallowly defined in a facia by an innermost crescent shaped wall 143 with an apex 143a closest to the main axis 108, and a pair of obtusely angled (at about 110°-140°, preferably about 120°-130°, and most preferably about 125°) divergent walls 144 extending outwardly from the apex 143a. However, the divergent walls 144 have their structural base at the outer cylindrical wall 156 (or 256 in the second embodiment). The hollow shape 142 is bisymmetrical and the divergent walls 144 each transition through an internal corner 143b wherefrom a pair of convergent walls 145 extend outwardly to meet at an outer acute angled internal corner 143c. The acute angle is preferably between 380-50°, preferably 40°-45°, and most preferably about 43°. The convergent walls 145 form internal sides of a pair of convergent arms 146 that merge at the neck 134. The convergent arms 145 are concavely curved so that they curve toward one another as they converge at the neck 134.

The star frame 140 combined with the general circular central hub 150 frame is extremely light and strong, providing flexibility in that the convergent arms 146 resiliently flex inwardly, whilst the peripheral roller axle ring and radial heads 132 structure stabilises each spoke 146 and adds rigidity to the overall frame 140. The convergent arms 146 flex against their bases 147. Adjacent convergent arms 146 of adjacent radial spokes 110 meet in a triangle base 147 that extends outwardly from the circular hub 150 to support each hollow shape 142. The innermost apex 143a is preferably located immediately radially adjacent the periphery of the central hub 150. The curved convergent arms 146 therefore include an inwardly arched wall 148 that extends from the radially outer meeting point 146b of the convergent arms 146 to the inner end 146a of the arm's 146 base. The arched walls 148, together with the star shaped center frame 140 including the central hub 150, provide a very strong and light structure that radially resists compression from centripetal loads applied to the omniwheel 100. In particular, each spoke 110 has a trefoil relationship to 2 other spokes to form a 3-pointed star shape. The contour L of a first spoke arm 146c of a first spoke 110a at its inner end is in line with the nearest spoke arm 146b of a second spoke 110b set at 120° to the first spoke 110a. This is a structural aspect that provides strength to the overall frame, with each individually thin spoke arm 146 directly opposing the centripetal forces applied through an in-line spoke 110b. The thin spoke arm 146 may have a thickness in a plane substantially parallel to the plane of the omniwheel 100 at the arm's 146 midpoint that is in the range of 3-10%, preferably 4-7%, and most preferably about 5%, of the omniwheel's radius R. In this way, each spoke arm 146c has an opposed corresponding spoke arm 146d adapted to resist compression forces applied therethrough, the respective bases 146a of each in-line spoke arm 146c,d being circumferentially off set by about 750-85°, preferably 80° relative to each other.

The radius r of the outer wall of the spoke arm 146 extending between its inner end 146a and its outer radial extent 146b where it merges with its pair spoke arm 146 is within the range of +/−10% of the radius R of the omniwheel 100 taken from the main axis 108 to the outer periphery 106. Preferably omniwheel 100 radius R is substantially equal to spoke arm 146 outer wall radius r.

The convergent arms 146 each extend from at or near a radially outer apex 149 of each triangular base 147. Two convergent arms 146 extend from each triangular base 147 and each extend outwardly in a curve approaching a pure radial line until the convergent arm 146 reaches the arrow neck 134 whereupon the continuous wall of the spoke 110 continues the curve as it transitions into the divergent curve of the radial head 112 and its triangular shaped head 132.

### Contour Path

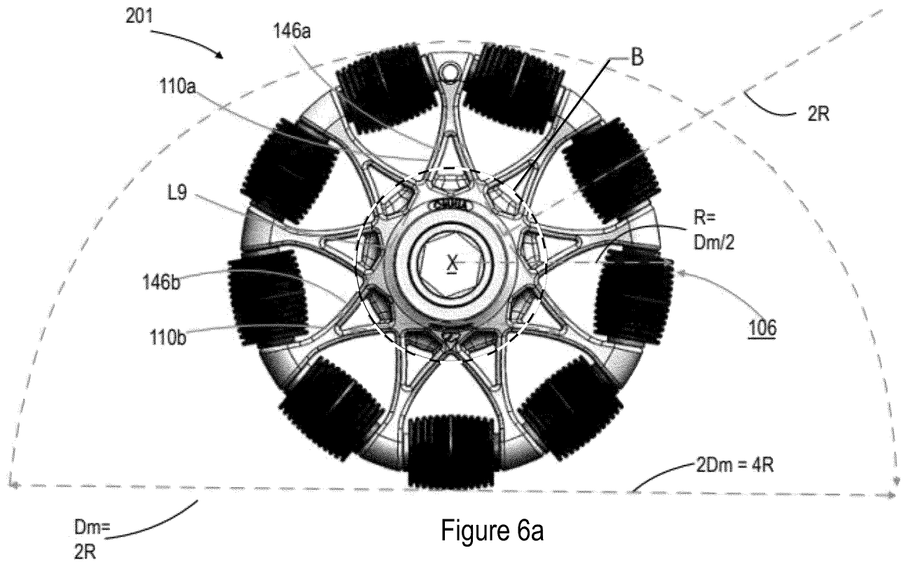

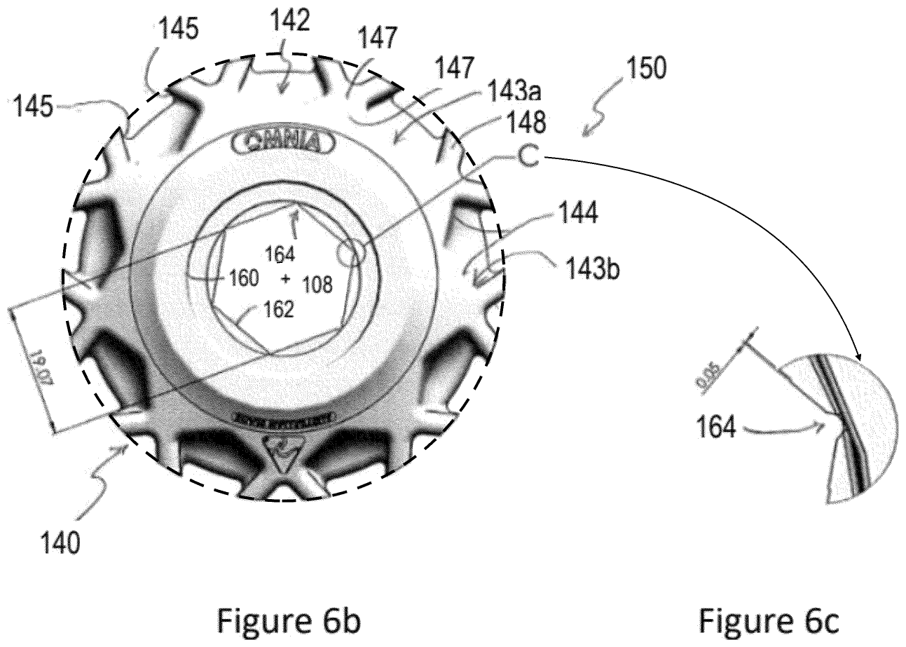

In FIG. 6a, the omniwheel frame 140 of one race 201 having 9 rollers 104 is shown highlighting the triangular 3-point star structure repeated and overlapping in the frame 140. Each first spoke arm 146a in side profile has a geometric relationship to a different second one of the spoke arms 146b belonging to a different one of the radial spokes 110b, such that the first and second spoke arms 146a,b lie along a common contour path following a curved line L9 with no inflection points, the curved line L9 extending through and between the first and second spoke arms 146a,b. The contour path has an average radius within 10% of the radius 2R of the omniwheel 100 (taken from the main axis X to the peripheral surface 106 of the omniwheel 100. The second spoke arm 146b belongs to a radial spoke 110b that is not adjacent or opposite the radial spoke 110a of the first spoke arm 146a.

The radius r of the curved line L9 (or L1,L2,L3) of the triangular star structure is the same as, or close to, twice the radius R of the omniwheel 200. The curved lines L1-L3 form a triangular star shape as shown in FIG. 2a which is a repeating and overlapping pattern around the wheel frame 240.

FIG. 1c shows an omniwheel 100 according to the first embodiment comprising a pair of rims 101,102, each including 8 rollers 104. The rollers 104 are supported by a radial spokes 410 arranged in overlapping 4-point star shapes defined by 4 curved lines L8.

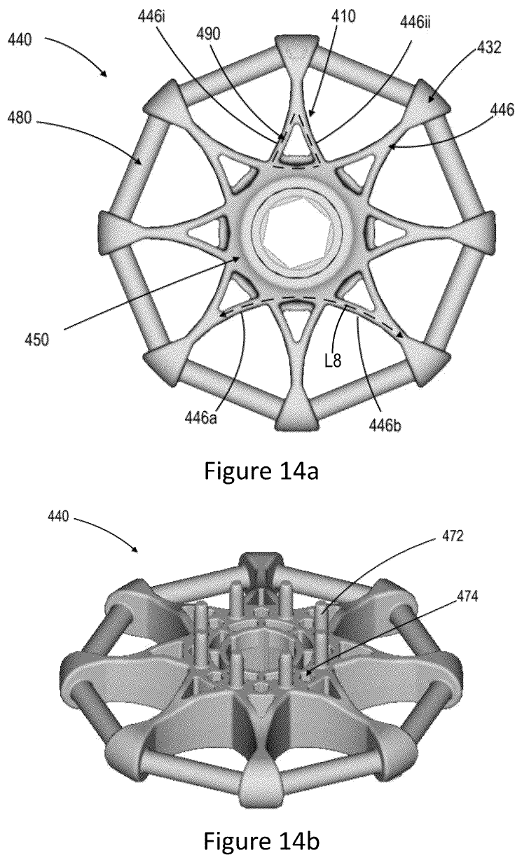

FIG. 14a shows a single omniwheel frame 440 according to the first embodiment in which the frame 440 is adapted to form part of an assembled dual rim omniwheel 100 in which each wheel frame 440 is adapted to support 8 rollers. The wheel frame 440 has 8 radial spokes 410 arranged in overlapping 4-point star shapes (see also FIG. 12a showing curved dotted lines following contours of curved lines L8).

Each first spoke arm 446a in side profile has a geometric relationship to a different second one of the spoke arms 446b belonging to a different one of the radial spokes 410b, such that the first and second spoke arms 446a,b lie along a common contour path following a curved line L8 with no inflection points, the curved line L8 extending through and between the first and second spoke arms 446a,b. The contour path has an average radius within 10% of the radius R of the omniwheel 400 (taken from the main axis to the peripheral surface 406 of the omniwheel 400. The second spoke arm 446b belongs to a radial spoke 410b that is not adjacent or opposite the radial spoke 410a of the first spoke arm 446a,

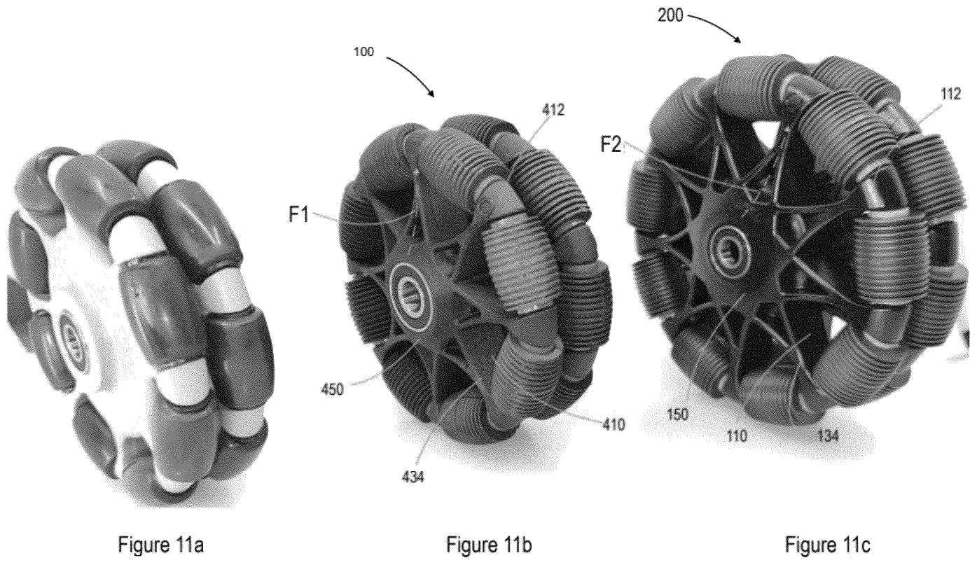

FIGS. 11a-c show side-by-side comparisons of a prior art omniwheel made by the Applicant and the omniwheels 100,400 according to the first and second embodiments. The difference in geometry of the triangular head 112,412 in which the head is much flatter and its side walls facing each bushing 120,420 end, and from which the roller axles extend, are less inclined to a radial line extending from the main axis X compared to the prior art example. Combined with the dual triangular, hourglass, dumbbell or “FIG. 8” structure of each spoke 110,410 and their elongate narrow neck 134,434. The narrowness in side profile of the neck 134,434 and spoke arms 146,446 does not present weak points in the frames 140,440. The neck 134,434 and spoke arms 146,446 extend from one side of the omniwheel 100,400 to the other, taking full advantage of the full width of the central hub 150,450 as the width of the frame 140,440 tapers radially outwardly along profile F1,F2. The narrowest width of the frame 140,440 corresponds to the width of the neck-radial head transition. The spoke 110,410 widths in a plane parallel to the main axis X from the central hub 150,450 radially outwardly are never larger than any portion of the spoke 110,410 radially inward thereof.

Referring to FIGS. 12a-12c, 13a-13c, there is shown a comparison of omniwheel frame 440 comprising 8 roller axles 480 and a 9 roller axle version of the frame of the omniwheel 200. The roller axles 480 are unitarily formed as part of the frame 440 in a single mould, together with the central hub 450, and the radial spokes 446 including the radial heads 432.

A hollow triangular structure 490 formed at the base of the spoke 410 by the pair of radial arms 446i-ii belonging to that spoke 410 is shown in FIG. 14a. The continuous curve L8 following the shared contours of the inline spoke arms 446a-b is demonstrated in FIGS. 12b and 14a. Referring to FIGS. 2b and 13a-b, the geometry of the 9 roller axle frame 240 is shown to have a structure reinforced by a symmetrical array of repeated and overlapping triangular star-shaped structures defined by curves L1-L3 that follow the curved contours of each spoke arm 146b to another spoke arm 146d of a spoke 110b not immediately adjacent to the first spoke 110a. This repeated triangular pattern provides an extremely strong wheel frame 240 body.

The non-adjacent spoke arms separated by only one intermediate spoke 110 in the 9 roller axle wheel frame 240 also have a strong geometric relationship through curved line L8i as shown in FIG. 13a. However, unlike the 4-pointed star shape of the 8 roller axle wheel frame 440, or the three-pointed star shape of the 9 roller axle wheel frame 240, the L8i curve does not form part of a symmetrical multi-pointed star shaped structure.

### Hub/Bore

The central hub 150 includes a bearing seat 160 which, in the second embodiment described with reference to FIGS. 4-9b, is combined with a hex inner bore 162. The hex inner bore 162 may be replaced by other polygonal shapes, such as a pentagonal or square key bore. As best seen in FIG. 6c, the corners 164 of the bore 162 are undercut to retain inserts (not shown) in a friction fit enhanced by the slight distortion of the polygonal shape 162 allowed by the undercuts 164. The undercuts 164 are internally radiused corners that resist splitting but allow flex whereby the bore 162 is able to slightly distort to receive a slightly oversized polygonal insert.

As shown in FIGS. 6b-c, the hub bore is fixed in a cylindrical bearing seat 160. During manufacture, differently configured or keyed inner bores can be inserted in the bore seat 160 to suit different applications.

### Dual Rim Wheels

Shown in FIGS. 4 and 7b-8 is an arrangement 270a for joining a pair of wheel races 201,202. Similar features with respect to the first embodiment share similar numbers in which the hundred designations is replaced with a two hundred designation (e.g. 200 for 100). The pairs of races 201,202 are joined by an interference engagement characterised by inserting pins of one shape into holes of a geometrically different shape. In the example shown, the engagement 270 includes round pins 272 inserted in hexagonal holes 274. The internal walls of the hexagonal hole 274 bear against the cylindrical pin 272 which distort slightly to provide the resistance and an interference fit. The hex hole 274 accommodate the pin 272. The pin 272 has a slightly larger diameter than the maximum breadth of the hexagonal hole 274. The arrangement 270 includes an array of pins 272a on the inner face 271 of the wheel body of first race 201. Advantageously, circumferentially offset from the array of pins 272a is a corresponding and complementary array of hexagonal recesses 274a. The offset arrangement of arrays 272a,274a on the same face 271 allow for a combination of two identical halves 201,202 to form a dual race symmetrical wheel body 200.

The central hub 150 defines a circular seat 160 that provides flexibility in the bore 162 that may be deployed, depending on size, and axle key or journal requirements for a particular application. For example, a driven robotic wheel 200 compared to a freely rotatable wheel 100 for conveying applications.

### Tension Distribution of Forces

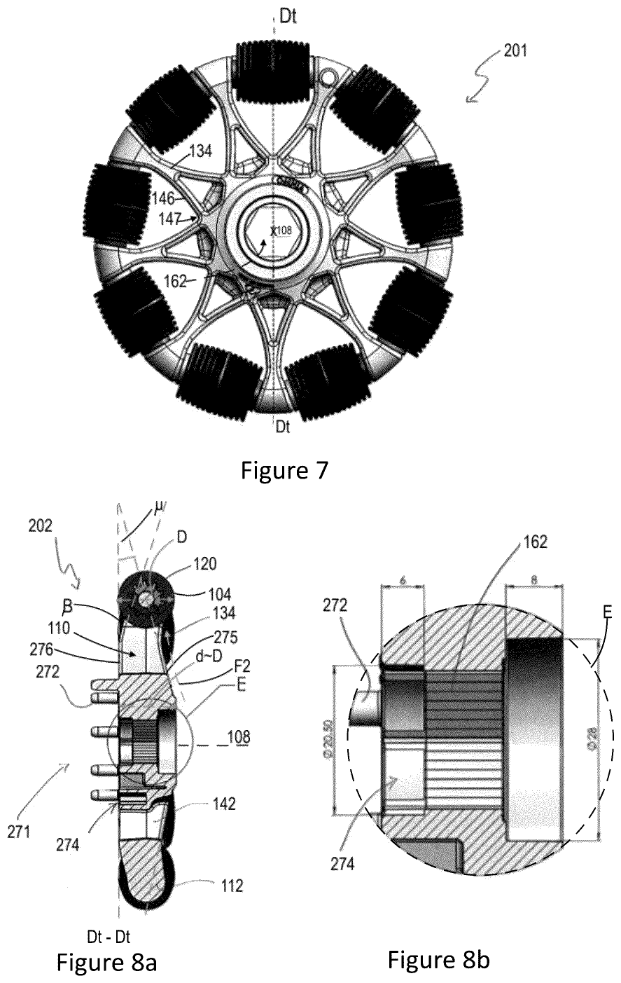

In FIG. 7b, there is shown the structural relationship between the diameter D of the rollers 104 and the depth d of the spokes 110 at their respective bases 147 in a direction parallel to the axis 108 of the bore 162. Diameter D is the same or close to (within 10%) of the depth d. After a brief shoulder at base 147, the outer face 275 of the spoke 110 slopes inwardly as it extends out radially at an angle β, where β is less than 20°, more preferably between 14-18°, most preferably 16°, relative to an inner wall 276 of the spoke 110. At the transition between the spoke arms 146 and the neck 134, there is a bend away from the inner wall 276 at an angle β, where β is the same or close to (within 20%) of angle β, more particularly is less than 25°, more preferably between 18-20°, most preferably 19°. The outer face 275 and inner face 276 of the neck 134 extend in directions close to (within 5°) to one another up to the radial head 112.

As shown in FIG. 8a, the angle β corresponds to the angle at which the radial head 112 extends forwardly (away from a complementary rim 202 forming part of an assembled dual rim omniwheel 200). The bend defined by angle β is located at the neck 134 of the spoke 110. Angle β is an obtuse angle formed with the inclination F2 of the front or outer face 275, as the front and rear faces 275,276 extend substantially parallel to one another. This spatial relationship and positioning of the spoke 110 which is recessed from the outer face of the central hub 150, and the radial head 112, which extends away from its complementary partner rim 201 in an assembled omniwheel 200, protects the spokes from impact damage and optimises space between diagonally adjacent rollers 104a,b to reduce the risk of rolling interference with each other.

The meaning of descriptive, precise or absolute terms such as “flexed”, “normal”, “parallel”, “horizontal”, “vertical” or “fully” includes the preceding qualifier “substantially or almost”, unless the context or contrary is expressly indicated.

Qualifying relative terms, such as “relatively”, “sufficiently”, “near”, “almost” or “substantially”, may be taken to indicate a variation in an absolute value of between 0° and 10° or between 0% and 10%, relative to the absolute value. For example, “near horizontal” may be taken to mean any orientation between 09 and 109 relative to the horizontal.

In the present specification, the term “integral” means formed of one body in a single process. In particular, the term “integrally formed” means formed of the one body without post-forming attachment of separately formed component parts. That is, “integrally formed” and the similar term “unitarily formed” mean formed in a single forming process and do not include post-forming attachment of component parts by means of fastener or other component fixing substances or methods.

Orientational terms used in the specification and claims such as vertical, horizontal, top, bottom, upper and lower are to be interpreted as relational and are based on the premise that the component, item, article, apparatus, device or instrument will usually be considered in a particular orientation, namely the main axis being horizontal in the present context.

In the present specification, the term “integral” means formed of one body in a single process. In particular, the term “integrally formed” means formed of the one body without post-forming attachment of separately formed component parts. That is, “integrally formed” and the similar term “unitarily formed” mean formed in a single forming process and do not include post-forming attachment of component parts by means of fastener or other component fixing substances or methods.

1. An omniwheel includes a wheel frame supporting a total of 8 or 9 peripheral rollers and a corresponding number of radially extending spokes, each spoke including a pair of radially extending curved spoke arms that radially outwardly converge to support a radial head adapted to support one end of a roller axle extending between adjacent pairs of radial heads on the same wheel frame, each spoke arm having a geometric relationship to another spoke arm of the wheel frame forming a multi-pointed star shape, which star shape is repeated and overlapping throughout the wheel frame structure.

2. The omniwheel as claimed in claim 1, wherein the star shape is defined by multiple in-line pairs of spoke arms together having a geometric connection across the wheel frame, the in-line pair of spoke arms shaped to conform to a contour path that follows a symmetrical curved line between the inline pair of spoke arms, the contour path having an average radius within 20%, preferably 10%, of either 2R or R, where R is the radius of the omniwheel from a main central rotational axis of the omniwheel to an outermost rim of the omniwheel corresponding to a ground-contacting surface 106 of one of the rollers on the wheel frame.

3. An omniwheel as claimed in claim 1, wherein each said spoke includes a pair of outwardly extending spoke arms that are concavely curved wherein they are widely spaced at the central hub and converge to meet at the spoke neck portion.

4. An omniwheel as claimed in claim 1, wherein each roller is has a sleeve that is overmoulded onto a bushing mounted on a roller axle on the frame, the radial head's side walls facing each bushing end are inclined to a radial line extending from the main axis to provide a dual triangular or hourglass structure of each spoke with the elongate narrow neck intermediate inner radial and outer radial triangular structures.

5. An omniwheel as claimed in claim 4, wherein the neck and spoke arms extend from one side of the omniwheel to the other, corresponding to the full width of the central hub 0 and tapering radially outwardly, so that a narrowest width of the frame corresponds to the width of the neck-radial head transition.

6. An omniwheel as claimed in claim 4, wherein the spoke widths in a plane parallel to the main axis from the central hub radially outwardly are never larger than any portion of the spoke radially inward thereof.

7. An omniwheel including a wheel frame supporting a total of 8 or 9 peripheral rollers and a corresponding number of radially extending spokes, each spoke including a pair of radially extending curved spoke arms that outwardly converge to meet at a spoke neck that supports a radial head adapted to support one end of a roller axle extending between adjacent pairs of radial heads on the frame, each roller axle having mounted thereto a roller, each spoke arm having a geometric relationship to another spoke arm of the wheel frame forming an inline pair of spoke arms with a geometric connection across the frame, the inline pair of spoke arms shaped to conform to a contour path that follows a symmetrical curved line between the inline pair of spoke arms, the contour path having an average radius within 10% of either 2R or R, where R is the radius of the omniwheel from a main axis of the omniwheel to a contact surface of the rollers.
